(19) United States
(12) Patent Application Publication
(10) Pub. No.: US 2011/0307314 A1
(43) Pub. Date: Dec. 15, 2011

(54) EXERCISE CREDIT EXCHANGE SYSTEM AND METHOD

(76) Inventor: John D. Frumer, Bowdoinham, ME (US)

(21) Appl. No.: 12/814,875

(22) Filed: Jun. 14, 2010

(51) Int. Cl. G06Q 30/00; G06Q 90/00

(52) U.S. Cl. 705/14.11; 705/500

(57) ABSTRACT

A system and method for securely measuring and tracking exercise performed by individuals and energy generated by human powered devices is provided. An amount of exercise and/or energy generated is quantified and converted to reward points usable in a rewards incentive program. Exercise performed and/or energy generated on exercise equipment is measured by measurement apparatus on the equipment. Reward points are issued locally to a user's portable stored value device or card, or may be accumulated on a remotely administered user account. A user interface disposed locally with the exercise equipment receives a user identification and provides credits to the user's stored value device or card, or provides notification to the user of credits being provided to the remote user account. A redemption point in communication with remote user accounts communicates over a network to verify sufficient credits and authorizes rewards to a user commensurate with available credits.

### BACKGROUND OF THE INVENTION

Energy expended by people performing physical exercise can be converted into useful energy by using generators and other energy conversion devices. Human powered generators are well known and have been the subject of many patented inventions. For example, U.S. Pat. No. 4,389,047 to Hall and U.S. Pat. No. 3,210,643 to Stern each describe early human powered generators. However, devices for converting human power to useful energy have not become popular because the amount of energy that can be generated by a single person is quite small.

Collectively, the amount of energy expended by humans during exercise is very large. For example, in many fitness centers dozens of pieces of fitness equipment are used almost continuously during a given day. It would be desirable to redirect some of the energy expended by fitness center clients which is now almost entirely lost as heat, for use elsewhere by transmission to municipal public power grid. A system and method for collecting energy generated by human powered devices is described in Applicant's pending U.S. patent application Ser. No. 12/408,422 which is incorporated herein by reference in its entirety. In order to provide motivation to entice the public to participate in a system of human powered energy generation, it would be desirable to provide a system for tracking energy generated by exercise equipment and providing for rewards commensurate to an amount of power generated.

### SUMMARY OF THE INVENTION

Illustrative embodiments of the present invention provide a system and method for securely measuring and tracking exercise performed by individuals and energy generated by human powered devices. An amount of exercise and/or energy generated is quantified and converted to reward points usable in a rewards incentive program. Exercise performed and/or energy generated on individual exercise equipment is measured by measurement apparatus on the equipment. In an embodiment of the invention, legacy exercise equipment, such as exercise equipment already in use may be retrofitted with a measuring apparatus, electric generator and/or user interface for use in accordance with embodiments of the invention.

Reward points are issued locally to a user's portable stored value device or card, or may be accumulated on a remotely administered user account. A user interface disposed locally with the exercise equipment receives a user identification and either provides points to the user's stored value device or card, or provides notification to the user of credits being provided to the remote user account. In an illustrative embodiment, the user identification is unique, protected, verifiable and secure.

A redemption point, in communication with remote user accounts, communicates over a network to verify sufficient credits and authorizes rewards to a user commensurate with available earned or awarded credits. The redemption point operator and/or the issuer of exercise points can also be rewarded for their participation in the exercise rewards program.

### BRIEF DESCRIPTION OF THE DRAWINGS

The foregoing and other features and advantages of the present invention will be better understood from the following detailed description of illustrative embodiments, taken in conjunction with the accompanying drawings in which:

FIG. 1 is a schematic block diagram illustrating a system for encouraging human powered energy generation according to an illustrative embodiment of the present invention; and

FIG. 2 is a process flow diagram illustrating a method for issuing exercise reward credits according to an illustrative embodiment of the present invention.

FIG. 3 is a process flow diagram illustrating method for exchanging exercise reward credits according to an illustrative embodiment of the present invention.

### DETAILED DESCRIPTION OF THE INVENTION

An illustrative embodiment of the invention provides an exercise credit exchange system and method in which a user enrolls to become a member of an exercise credit exchange program and may pay an enrollment fee, for example. Upon enrollment, the user is issued a memory device such as swipe card bearing a chip or magnetic strip, for example, a portable memory device or other type of “key”. When the member utilizes exercise equipment an amount of credit associated with their workout is registered on their key and on a corresponding user account maintained by a program administrator, for example. Keys can store the credit information themselves and/or may communicate the credit information via an electrical connection or wirelessly to a networked module for remote storage and/or administration, for example.

The amount of credit may be directly related to an amount of time that a user is using a particular piece of exercise equipment, an amount of work that the user performs using a particular equipment or some combination of time and work expended on the particular equipment, or achievement of a fitness goal, for example. Alternatively, the amount of credit may be awarded for time spent at a heath club or for simply visiting a health club. In an illustrative embodiment, the amount of credit is awarded based upon an amount of energy generated by a member and transmitted to a distribution grid as the user uses exercise equipment having generating/transmitting capability. Extra “green” points may be awarded for energy generated on certain types of equipment, or at certain locations, for example.

Points of varying amounts may be provided to reward certain other actions by the member, such as for joining a health club, making certain purchases or expenditures at a health club (for juices, power bars, food, coffee, water, equipment, clothing, locker rentals, preferred uses of facilities, etc.), for example. In an illustrative embodiment, reward points may be exchanged by a user for value, for example at a redemption point.

In the illustrative embodiment, the amount of credit and information aggregated by the member can be transported and transferred between or among members of the member's family or affinity group, for example, without regard to geographic location. The member's account information related to aggregation and use of exercise credits may be reviewable by the member over the Internet, for example.

The key and the user account are securely maintained to prevent tampering and to protect the integrity of the information stored. The exercise credits are transportable in that they may be earned/aggregated at any health/fitness club participating in the exercise credit exchange program wherever a member happens to be and with any participating partner, for example. In an illustrative embodiment, the exercise credits may also be aggregatable with other rewards programs, such as frequent flyer miles, for example.

The exercise credits correspond to or can be exchanged for or translated into rewards points that are redeemable for value such as cash, merchandise, discounts, air travel, hotel stays, or utility payments, for example. Illustratively, credits can be redeemable at the club level for value such as discounts or merchandise, at a participating partner for services/merchandise or from a financial institution such as a bank to initiate a banking relationship, or receive more favorable terms in an existing banking relationship, for example. Exercise credits may also be exchanged to receive discounted health insurance or life insurance premiums as indication of living a healthy lifestyle. In the illustrative embodiment, participating partners my also be required to pay certain fees to be allowed participation in the exercise credit exchange program.

The various embodiments of an exercise credit exchange system as described herein provide incentive to exercise, incentive to be loyal to participating health clubs and incentives to utilize services and/or products of participating partners. In addition to exchanging exercise credits for goods and services, it is envisioned that some number of exercise credits could be exchanged for carbon credits as part of a governmental or commercial cap and trade system of environmental regulation.

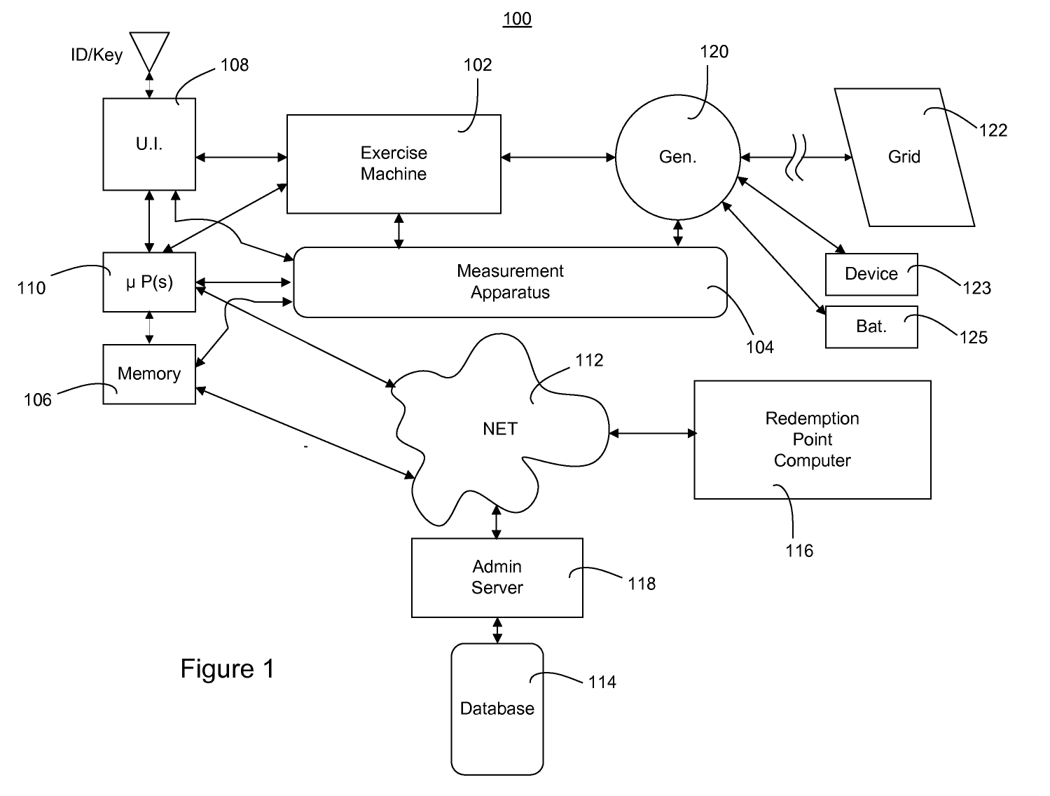

An exercise reward system according to an illustrative embodiment of the present invention is described with reference to FIG. 1. The exercise reward system 100 includes at least one piece of exercise equipment 102 and a measurement apparatus 104 configured to quantify an amount of exercise performed by a user on the exercise equipment 102. At least one electronic memory 106 is configured to store exercise credits identified to the user in response to the quantified amount of exercise performed.

In the illustrative embodiment, a user interface 108 is configured in communication with the measurement apparatus 104. The user interface is configured for receiving a user identifier for identifying the credits for association with the user. In an illustrative embodiment, the user interface is configured for notifying the user of an amount of the credits associated with the user. At least one processor 110 is configured in communication with the measurement apparatus 104. The processor 110 is configured to receive the quantified amount of exercise from the measurement apparatus 104 and convert the quantified amount of exercise to exercise credits based on a predetermined formula. In an illustrative embodiment, the predetermined formula can determine a credit amount based on bonuses or incentives, for example.

At least one network 112 is provided in communication with the processor 110 and configured for communicating the exercise credits to the electronic memory 106. In an illustrative embodiment the electronic memory 106 may include a portable memory device such as a stored value card, a USB memory stick or an RFID transponder, for example.

The illustrative embodiment also includes a database 114 operable in conjunction with the processor 110 and the memory 106 for accumulating and storing exercise credits and corresponding user identifiers. At least one redemption point computer 116 can be configured in communication with the network 112 for receiving at least a portion of the redemption points and providing value to the user in exchange for the received redemption points. In at least one embodiment of the invention, credits may be stored in one or more user accounts on the database 114 wherein the accounts may be managed by software running on an administration server 118 in communication with the network, for example.

The various embodiments of the present invention may include a human powered generator 120 configured with the exercise equipment for generating electricity in response to use of the exercise equipment 102 by the user. Circuitry in communication with the generator 120 is configured for transmitting the electricity to a power distribution grid 122, for example. In the illustrative embodiment, the quantified amount of exercise performed is a measure of the electricity transmitted to the power grid 122, for example. The power generated may also be used for powering an electrical device 123, or charging a battery 125, for example.

Embodiments of human powered exercise devices are described in Applicant's co-pending U.S. patent application Ser. No. 12/408,422 which is incorporated herein by reference. It should be understood that exercise equipment 102 having a generator 120, user interface 108 and/or measurement apparatus 104 according to embodiments of the present invention may be manufactured in such a configuration in the factory and sold as an integrated piece of equipment. Alternatively, it should be understood by persons having ordinary skill in the art that existing exercise equipment 102 including equipment long deployed in fitness centers and homes, for example, could be retrofitted with generators 120, user interfaces 108, and/or measurement apparatus 104 within the scope of the present invention.

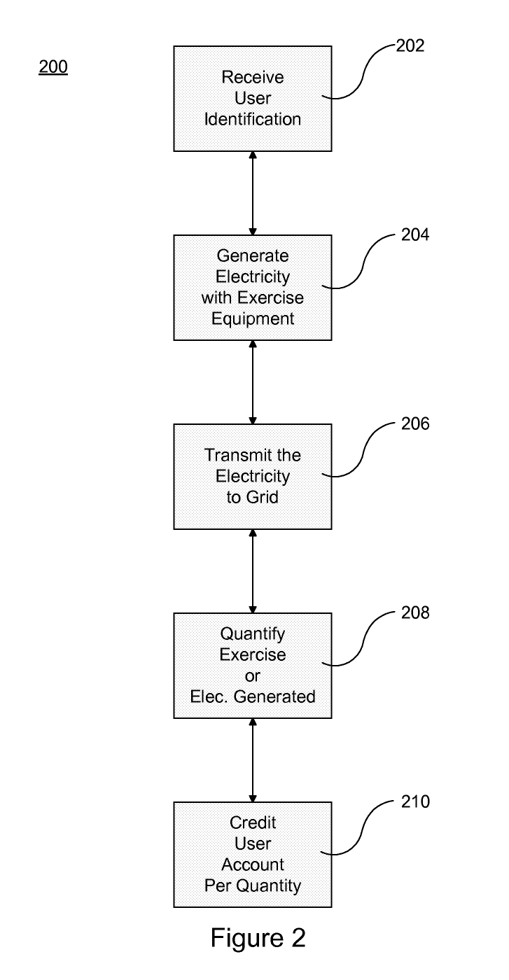

In another embodiment which is described with reference to FIG. 2, the present disclosure provides a method 200 for issuing reward credits. The method 200 includes the steps of receiving identification of an exercise equipment user 202 and quantifying 208 an amount of exercise performed by the user. Exercise credits are added 210 to an account identified to the user in response to the quantified amount of exercise performed by the user on the exercise equipment. Calculation of an amount of exercise credits may also be based on various bonuses and/or incentives, for example.

In the illustrative embodiment, electricity is generated 204 by the user's exertion on the exercise equipment. The electricity may be used directly for charging a battery or powering an electric device, or it may be supplied to a power distribution grid 206. In the illustrative embodiment, the quantified amount of exercise performed for which the user receives credit is a measure of the electricity transmitted to the power distribution grid, or used for charging a battery or powering an electric device, for example.

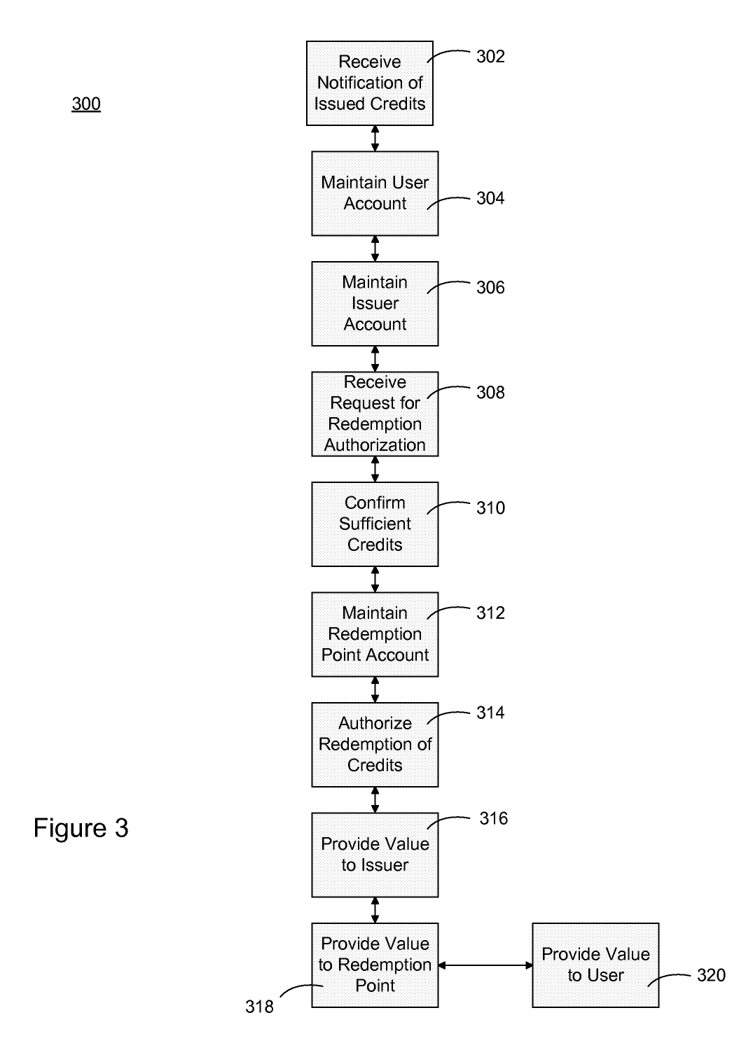

In another embodiment of the invention which is described with reference to FIG. 3, a method for exchanging reward credits 300 is provided. The method includes the steps of receiving a notification 302 of a number of exercise credits issued to an exercise equipment user in exchange for an amount of exercise performed by the user on the exercise equipment; and maintaining 304 a user account of exercise credits identified to the user. In the illustrative embodiment, the exercise credits are a measure of electricity generated by the user by using the equipment and transmitted to a power distribution grid. In an illustrative embodiment, an issuer account is maintained 306 for one or more issuers to keep track of an amount of exercise credits issued by particular issuers.

In the illustrative embodiment, the method includes the steps of receiving a request 308 to authorize a redemption of exercise credits by the user and confirming 310 that the user account includes sufficient exercise credits to satisfy the request. Authorization for the redemption is issued 314 in response to the confirmation step(s) 310.

In an illustrative embodiment, an issuer account of exercise credits issued by an issuer is maintained 306. Value is provided 316 to the issuer as a function of an amount of exercise credits issued to the user and redeemed at the redemption point. In the illustrative embodiment, a redemption point account recording exercise credits redeemed at a redemption point may also be maintained 312. Value is provided 318 to the redemption point operator as a function of exercise credits redeemed at the redemption point. In the illustrative embodiment, value is also provided 320 to the user at the redemption point.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. An exercise reward system, comprising:
at least one piece of exercise equipment;
a measurement apparatus configured to quantify an amount of exercise performed by a user using the exercise equipment;
at least one electronic memory configured to store exercise credits identified to the user in response to the quantified amount of exercise performed.

2. The system of claim 1, comprising:
a user interface in communication with the measurement apparatus and configured for receiving a user identifier for identifying the credits for association with the user.

3. The system of claim 2, wherein the user interface is configured for notifying the user of an amount of the credits associated with the user.

4. The system of claim 1, comprising:
at least one processor in communication with the measurement apparatus and configured to receive the quantified amount of exercise from the measurement apparatus and to convert the quantified amount of exercise to exercise credits based on a predetermined formula.

5. The system of claim 4, comprising:
at least one network in communication with the processor and configured for communicating the exercise credits to the electronic memory.

6. The system of claim 5, comprising:
a database operable in conjunction with the processor and the memory for accumulating and storing exercise credits and corresponding user identifiers.

7. The system of claim 5, comprising:
at least one redemption point computer in communication with the network and configured for receiving at least a portion of the redemption points and providing value to the user in exchange for the received redemption points.

8. The system of claim 1, wherein the electronic memory comprises a portable memory device.

9. The system of claim 8, wherein the portable memory device is a member of the group consisting of stored value card, USB memory stick and RFID transponder.

10. The system of claim 1, comprising:
a human powered generator configured with the exercise equipment for generating electricity in response to use of the exercise equipment by the user.

11. The system of claim 10, comprising:
circuitry in communication with the generator configured for transmitting the electricity to a power distribution grid.

12. The system of claim 11, wherein the quantified amount of exercise performed comprises a measure of the electricity transmitted to the power grid.

13. A method for issuing reward credits, comprising:
receiving identification of an exercise equipment user;
quantifying an amount of exercise performed by the user;
adding exercise credits to an account identified to the user in response to the quantified amount of exercise performed by the user on the exercise equipment.

14. The method of claim 13, comprising:
generating electricity with the exercise equipment; and
supplying the electricity to a power distribution grid;
wherein the quantified amount of exercise performed comprises a measure of the electricity transmitted to the power distribution grid.

15. A method for exchanging reward credits, comprising:
receiving a notification of a number of exercise credits issued to an exercise equipment user in exchange for an amount of exercise performed by the user on the exercise equipment; and
maintaining a user account of exercise credits identified to the user.

16. The method of claim 15, wherein the exercise credits comprise a measure of electricity generated by the user by using the equipment and transmitted to a power distribution grid.

17. The method of claim 15, wherein the exercise credits comprise a measure of electricity generated by the user by using the equipment and used to charge a battery.

18. The method of claim 15, wherein the exercise credits comprise a measure of electricity generated by the user by using the equipment and used to power an electric device.

19. The method of claim 15, comprising:
receiving a request to authorize a redemption of exercise credits by the user;
confirming that the user account includes sufficient exercise credits to satisfy the request; and
issuing an authorization for the redemption in response to said confirmation.

20. The method of claim 15, comprising:
maintaining an issuer account of exercise credits issued by an issuer;
providing value to the issuer as a function of an amount of exercise credits issued to the user.

21. The method of claim 15, comprising:
maintaining a redemption point account of exercise credits redeemed at redemption point; and
providing value to the redemption point operator as a function of exercise credits redeemed at the redemption point.
